(19) United States
(12) Patent Application Publication
(10) Pub. No.: US 2014/0369047 A1
(43) Pub. Date: Dec. 18, 2014

(54) Frame and Light Apparatus

(71) Applicant: Everlight Electronics Co., Ltd., New Taipei City (TW)

(72) Inventors: Yung Chieh Chen, New Taipei City (TW); Jung Chiuan Lin, New Taipei City (TW); Feng-Ting Hsu, New Taipei City (TW); Chien-Chang Pei, New Taipei City (TW)

(21) Appl. No.: 14/306,803

(22) Filed: Jun. 17, 2014

Related U.S. Application Data
(60) Provisional application No. 61/836,409, filed on Jun. 18, 2013.

(30) Foreign Application Priority Data
Apr. 10, 2014 (TW) 103113148

(51) Int. Cl. F21V 21/30; F21V 23/00

(52) U.S. Cl. CPC F21V 21/30; F21V 23/002; F21Y 2105/00
USPC 362/285; 362/427; 362/341

(57) ABSTRACT

A frame for a light apparatus and the light apparatus are provided. The light apparatus has at least one light-emitting diode chip. The frame includes an electrode portion, a first body and a second body. The frame has a first portion, a second portion and a bendable connecting portion which is located between the first portion and the second portion. An angle is formed between the first portion and the second portion by the connecting portion. The first body is disposed on the first portion. The first body has a first recess exposing a portion of a first electrode surface of the first portion. The light-emitting diode chip is disposed in the first recess and connected with the first electrode surface electrically. The second body is disposed on the second portion and exposes a portion of the connection surface of the second portion.

### CROSS REFERENCE TO RELATED PATENT APPLICATION

The present disclosure claims the priority benefit of U.S. patent application Ser. No. 61/836,409, filed on 18 Jun. 2013, and Taiwan Patent Application No. 103113148, filed on 10 Apr. 2014, which are incorporated by reference in their entirety.

### TECHNICAL FIELD

The present disclosure provides a frame and a light apparatus and, more particularly, a frame for accommodating a light-emitting diode (LED) chip and a light apparatus comprising the frame.

### BACKGROUND

Light apparatuses with LED chips have been widely used for lighting. FIG. 1 illustrates a schematic view of a conventional light apparatus 1. The light apparatus 1 has a frame 10 and a plurality of LED chips 11. The frame 10 is used for accommodating the LED chips 11. The light apparatus 1 is disposed on a substrate 800. The light rays of the LED chips 11 can transmit through the frame 10.

Furthermore, the drawbacks of the conventional light apparatus 1 lie in that the frame 10 is fixed on the substrate 800, so the light generated by the light apparatus 1 can only be transmitted in a single direction. If the direction in which the transmitted light of the light apparatus 1 needs to be adjusted, the planar substrate 800 must be further modified to have a curved surface or several different bevels to accommodate several light apparatuses 1 so that the light apparatuses 1 can emit light towards different directions. The complicated outline of the substrate 800 makes it inconvenient to be manufactured. It is also likely that the light apparatus 1 cannot be disposed on a non-planar substrate stably, so the light apparatus 1 may be in poor contact with the substrate.

Accordingly, it is important in the art to provide a frame for use in a light apparatus which can accommodate light emitting elements to improve the aforesaid drawbacks.

### SUMMARY

An objective of the present disclosure is to provide a frame and a light apparatus that comprises the frame. The frame is adapted to accommodate a light emitting element so that the light emitting element accommodated in the frame can emit light towards various different directions.

To achieve the aforesaid objective, the frame of the present disclosure comprises an electrode portion, a first body and a second body. The electrode portion has a first portion, a second portion and a bendable connection portion located between the first portion and the second portion, wherein an angle is formed between the first portion and the second portion by the connection portion. The first body is disposed on the first portion. The first body has a first recess partially exposing a first electrode surface of the first portion. The second body is disposed on the second portion and exposes a connection surface of the second portion.

In addition to the aforesaid frame, the light apparatus of the present disclosure also comprises a first LED chip and a sealant. The first LED chip is accommodated in the first recess and electrically connected with the electrode portion. The sealant is accommodated in the first recess and adapted to cover the first LED chip and the first electrode surface.

The detailed technology and preferred embodiments described in the present disclosure are described in the following paragraphs accompanying the appended drawings for people skilled in this field to well appreciate the features of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a schematic perspective view of a conventional light apparatus;

FIG. 2A is a schematic perspective view of a frame according to a first embodiment of the present disclosure;

FIG. 2B is another schematic perspective view of the frame according to the first embodiment of the present disclosure;

FIG. 3A to FIG. 3C are schematic side views of the light apparatus of the first embodiment of the present disclosure when the angle θ is 90 degrees, 135 degrees, and 180 degrees respectively;

FIG. 4A is a schematic perspective view of a light apparatus according to the first embodiment of the present disclosure;

FIG. 4B is another schematic perspective view of the light apparatus according to the first embodiment of the present disclosure;

FIG. 5A is a schematic perspective view of a light apparatus according to a second embodiment of the present disclosure;

FIG. 5B is another schematic perspective view of the light apparatus according to the second embodiment of the present disclosure;

FIG. 6A is a schematic perspective view of a light apparatus according to a third embodiment of the present disclosure;

FIG. 6B is another schematic perspective view of the light apparatus according to the third embodiment of the present disclosure;

FIG. 7A is a schematic perspective view of a light apparatus according to a fourth embodiment of the present disclosure;

FIG. 7B is another schematic perspective view of the light apparatus according to the fourth embodiment of the present disclosure;

FIG. 8A is a schematic perspective view of a light apparatus according to a fifth embodiment of the present disclosure;

FIG. 8B is another schematic perspective view of the light apparatus according to the fifth embodiment of the present disclosure;

FIG. 9A is a schematic perspective view of a light apparatus according to a sixth embodiment of the present disclosure; and

FIG. 9B is another schematic perspective view of the light apparatus according to the sixth embodiment of the present disclosure.

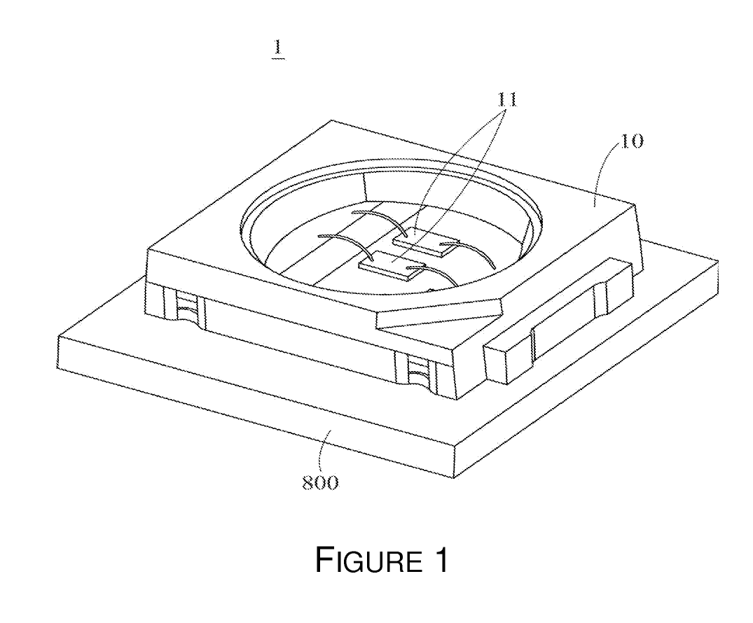

### DETAILED DESCRIPTION OF PREFERRED EMBODIMENTS

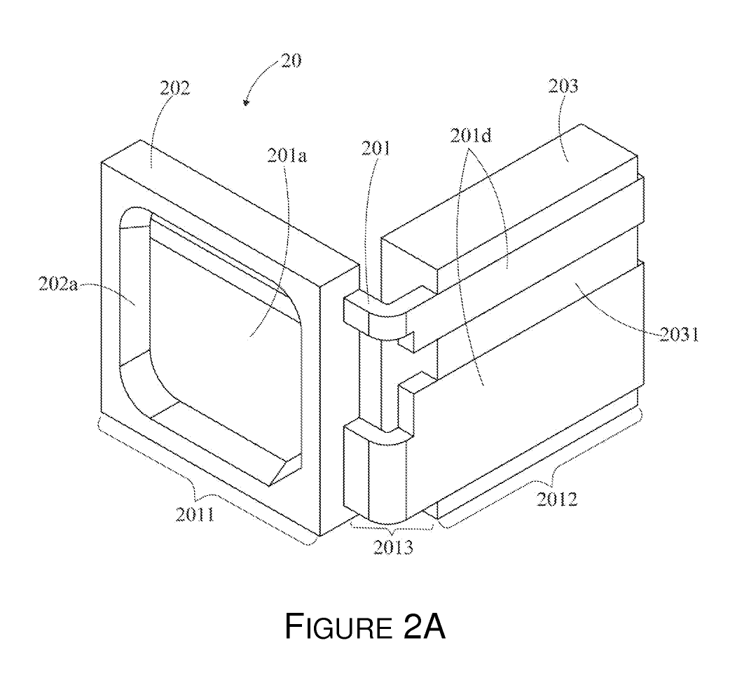

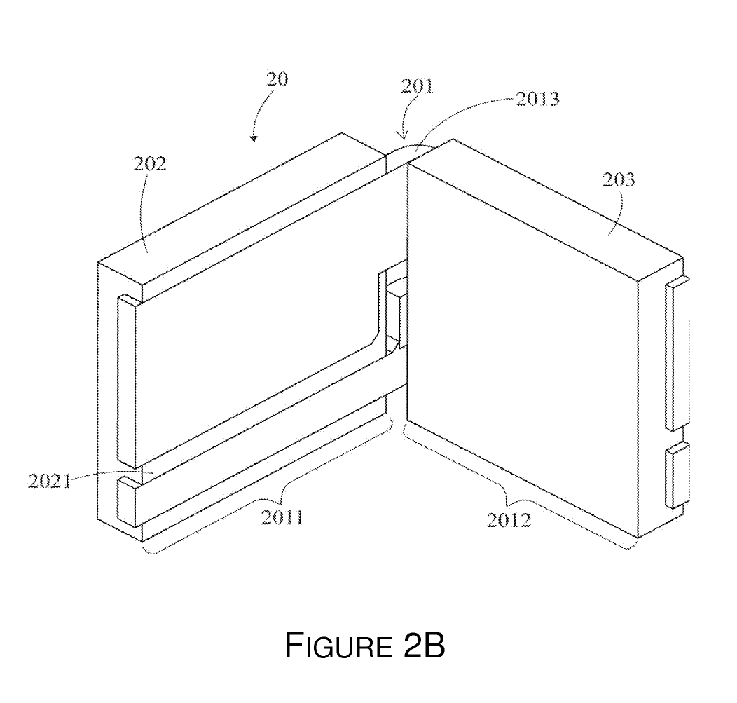

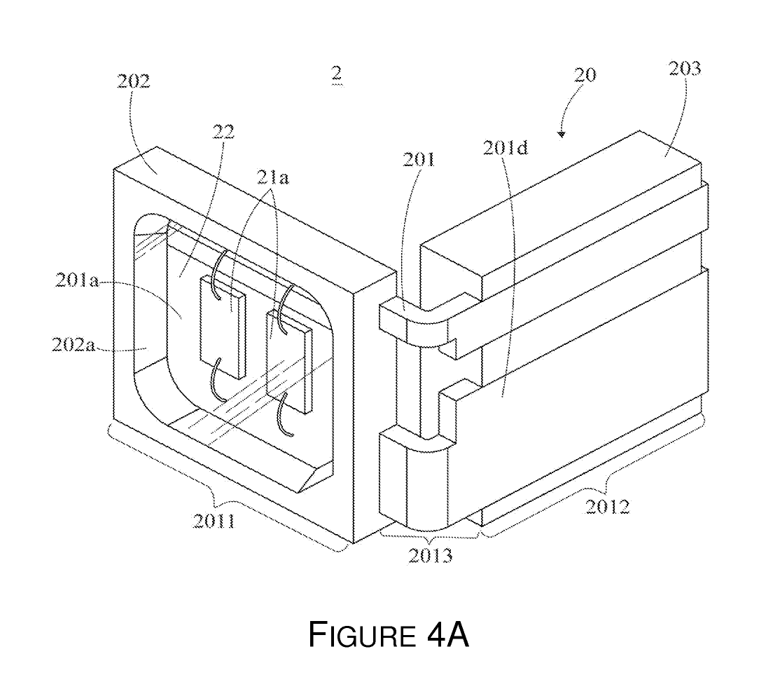

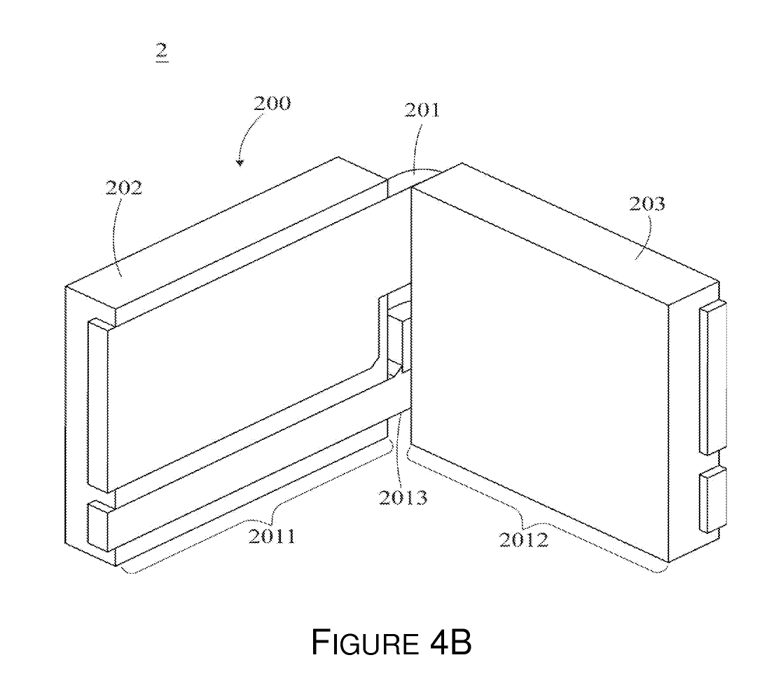

FIGS. 2A and 2B illustrate schematic perspective views of a frame 20 according to a first embodiment of the present disclosure when being observed from different perspectives. FIGS. 4A and 4B are schematic perspective views of a light apparatus 2 according to the first embodiment of the present disclosure when being observed from different perspectives. The frame 20 is for use in the light apparatus 2. The light apparatus 2 further comprises a first light-emitting diode 21a and a sealant 22. The structure of the frame 20 will firstly be described in detail hereinafter.

Still with reference to FIGS. 2A and 2B, the frame 20 comprises an electrode portion 201, a first body 202 and a second body 203. The electrode portion 201 has a first portion 2011, a second portion 2012 and a connection portion 2013. In this embodiment, the connection portion 2013 is bendable and located between the first portion 2011 and the second portion 2012. An angle θ may be formed between the first portion 2011 and the second portion 2012 by the connection portion 2013. The first body 202 is disposed on the first portion 2011. The first body 202 has a first recess 202a partially exposing a first electrode surface 201a of the first portion 2011. The second body 203 is disposed on the second portion 2012 and exposes a connection surface 201d of the second portion 2012.

The light apparatus of the present disclosure may have at least one first LED chip. The light apparatus 2 has two first LED chips 21a in embodiments of the present disclosure. In detail, with reference to FIGS. 4A and 4B, the first LED chips 21a are accommodated in the first recess 202a and disposed on the first electrode surface 201a of the electrode portion 201. The first LED chips 21a can be electrically connected to the electrode portion 201 in any way. As shown in FIG. 4A, the first LED chips 21a of the present disclosure may be electrically connected with the positive electrode and the negative electrode of the first electrode surface 201a of the electrode portion 201 through wires. The sealant 22 is accommodated in the first recess 202a and adapted to cover the first LED chips 21a and the first electrode surface 201a. The sealant 22 may be made of a light-transmissive material and may also have a fluorescent material.

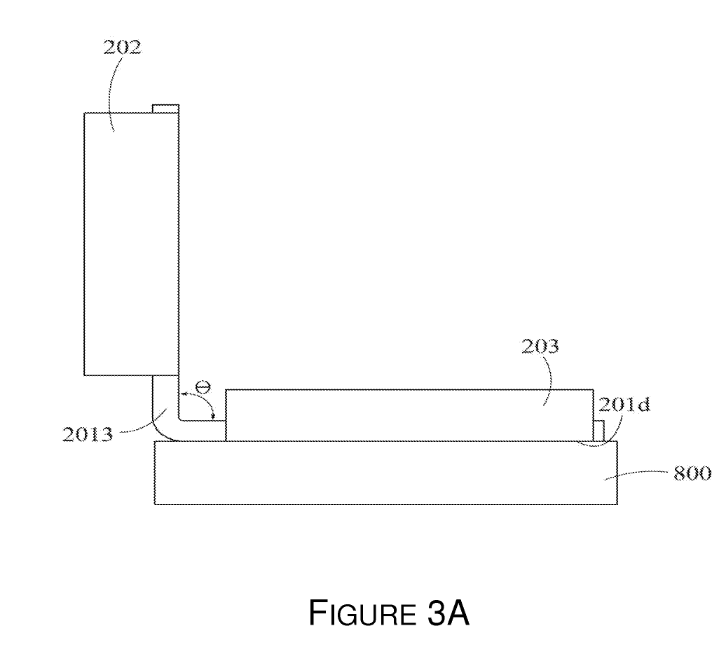

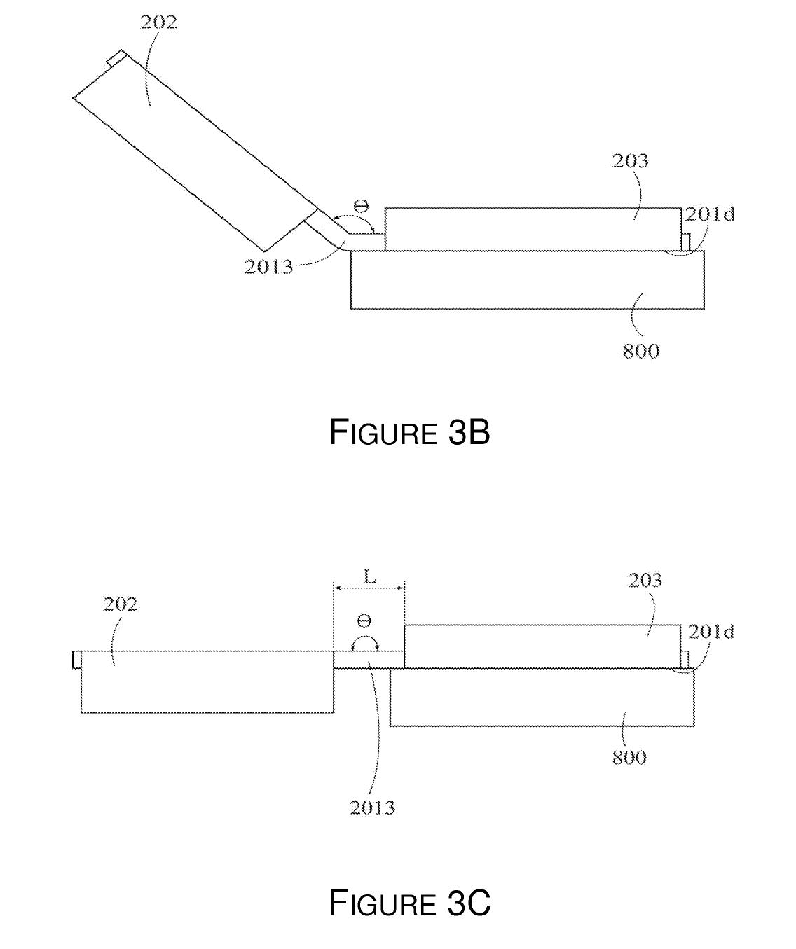

FIGS. 3A, 3B and 3C illustrate side views of the frame when the bend angle θ of the connection portion 2013 is 90 degrees, 135 degrees, and 180 degrees respectively in the first embodiment of the present disclosure. The light apparatus 2 may be electrically connected with a substrate 800 through the connection surface 201d of the electrode portion 201 so that the first LED chips 21a can be energized and emits light. In other words, the electrical energy or electrical signals can be transferred from a power source or a signal source to the first LED chips 21a through the connection surface 201d of the second portion 2012, the connection portion 2013, and the first electrode surface 201a of the first portion 2011 sequentially.

It shall be appreciated that in other embodiments of the present disclosure, the connection surface 201d may be electrically connected with a power source or a signal source. The connection portion 2013 is bent depending on the practical needs to change the angle θ. Accordingly, the first LED chips 21a accommodated in the first body 202 will emit light towards different directions. In other embodiments of the present disclosure, the angle θ may be between 0 degrees and 180 degrees and, preferably, is 90 degrees, 135 degrees or 180 degrees, although it is not limited thereto. The angle θ may be adjusted to be between 45 degrees and 135 degrees (e.g., 0 degrees, 45 degrees, 60 degrees, or 120 degrees) depending on the environment in which the frame is to be disposed and depending on practical needs. The method of bending the connection portion 2013 is not limited in the present disclosure. As illustrated in an embodiment of the present disclosure, the second body 203 is fixed on a stage with a 90-degree corner. The center of the connection portion 2013 is aligned with the corner. Stress is applied to the first body 202 so that the frame 20 is bent to 90 degrees along the corner. As can be readily appreciated by those of ordinary skill in the art from the aforesaid embodiments, the angle of the corner can be changed arbitrarily to control the bend angle of the frame 20.

When the angle θ of the connection portion 2013 is bent to 180 degrees, the first body 202 and the second body 203 have a longest interval L therebetween. The longest interval L needs to be larger than the thickness of the first body 202 or the second body 203. Otherwise, the first body 202 and the second body 203 would collide with or abut against each other when the connection portion 2013 is bent, thus preventing the connection portion 2013 from being bent into a predetermined bend angle θ.

To reduce the stress required to bend the connection portion 2013, the connection portion is preferably narrowed either entirely or partially; that is, the width of the connection portion 2013 is entirely or partially made to be smaller than the width of the first portion 2011 and/or the second portion 2012. Specifically, the narrowed area may be used to accommodate the strain generated when the connection portion is bent. In an implementation where the connection portion is partially narro wed, the position to be narrowed can be disposed arbitrarily depending on the subsequential application so that the bent position can be controlled precisely. For example, the connection portion 2013 may be narrowed at a position where it protrudes from the first body 202 (or the second body 203) for one third of the thickness of the first body 202 (or the second body 203) so that the bent portion can be adjusted to achieve a desired bend angle. More preferably, to maintain an appropriate connection strength, the width of the connection portion 2013 is made to be larger than half of the width of the first portion 2011 and/or half of the width of the second portion 2012. As shown in FIG. 2A, after protruding from the second body 203 for a certain distance, the connection portion 2013 is narrowed to control the bent position. The narrowed width is smaller than the width of the first portion 2011 and the width of the second portion 2012. Moreover, in another embodiment of the present disclosure, a dent (not shown) may also be formed in the connection portion 2013 for use as the bent portion.

To avoid short circuiting of the electrode portion 201 or to prevent the electrode portion 201 from interfering with other signal sources, the connection portion 2013 and the other electrode surface opposite the first electrode surface 201a are preferably covered by an insulating layer (not shown) made of an insulating material. If necessary, the connection portion 2013 and the other electrode surface opposite the first electrode surface 201a or the additionally applied insulating layer may also be directly covered by a reflective layer (made of a reflective material) to increase the reflectance of the diffused light. Meanwhile, when the light apparatus is assembled with other light apparatuses to form a light emitting module, the overall light-emitting efficiency of the light emitting module can be increased.

In the present disclosure, the first electrode surface 201a and the connection surface 201d may be located at the same side or at different sides of the electrode portion 201 depending on practical needs. In this embodiment, the first electrode surface 201a and the connection surface 201d are located at the same side of the electrode portion 201. However, the first electrode surface and the connection surface may also be located at different sides of the electrode portion 201 in other embodiments, e.g., a third embodiment which will be described hereinafter.

The second body 203 may be a block (especially a solid block), and may partially cover the second portion 2012 without having any recess. Accordingly, the whole frame 20 can be moved by using a vacuum robot arm to pick up the second body 203 so that the frame 20 can be used in automated equipment. The first body 202 and the second body 203 may be made of an insulating material, and preferably made of a plastic filled with a reflective filler or of a transparent material. In the preferred embodiments of the present disclosure, a ratio of the weight of the first body 202 to that of the second body 203 is 0.8 or less. Therefore, when the frame is bent, i.e., when the angle θ is less than 180 degrees, the second body 203 can still lie in the horizontal plane due to the relatively heavy weight thereof so that the automated equipment can pick up the frame 20 precisely.

Of course, the number of bodies in the frame and the light apparatus may be adjusted depending on the practical needs, and each of the bodies may optionally further have a recess to accommodate more LED chips. Thus, in the following description, the frame and the light apparatus of the first embodiment of the present disclosure will be taken as a prototype to describe embodiments derived with respect to the number of bodies or whether each of the bodies has a recess.

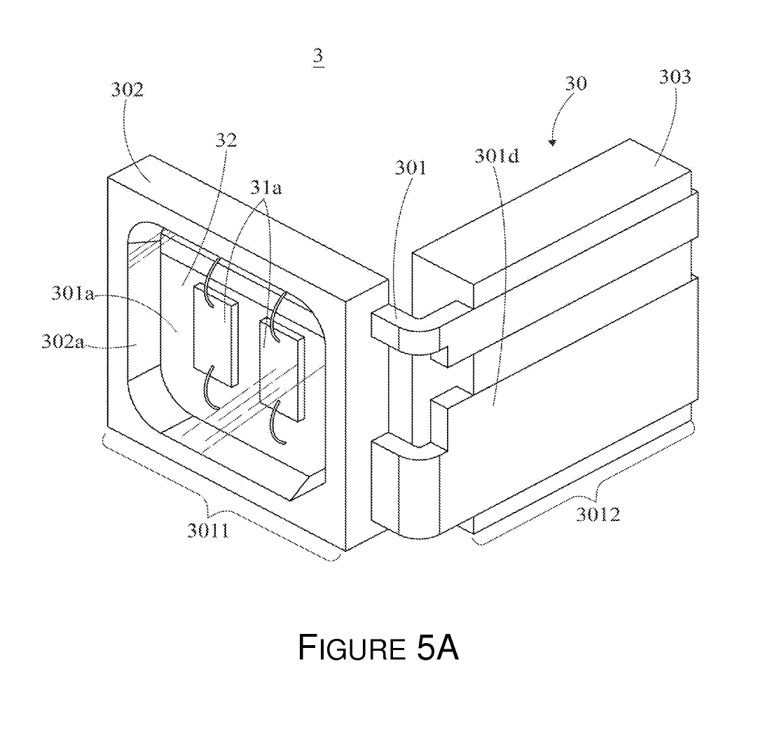

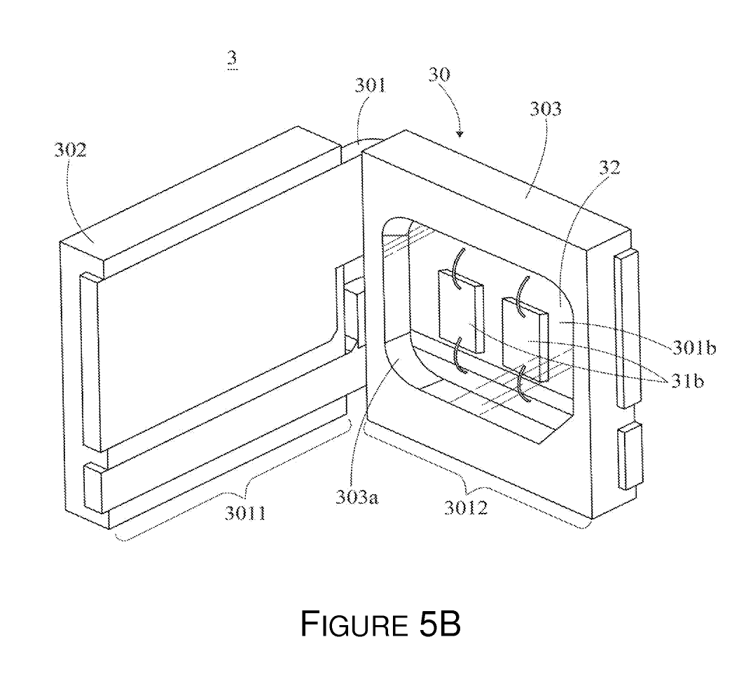

FIGS. 5A and 5B are schematic perspective views of a light apparatus 3 and a frame 30 according to a second embodiment of the present disclosure when being observed from different perspectives. In the frame 30 of the second embodiment, the frame 30 also has an electrode portion 301, a first body 302 and a second body 303. As in the first embodiment, the light apparatus 3 of this embodiment has the frame 30, a first LED chip 31a and a sealant 32. A connection surface 301d of the electrode portion 301 may be electrically connected with a substrate or other electronic elements. This embodiment differs from the first embodiment in that the light apparatus 3 further has a plurality of second LED chips 31b (in other embodiments of the present disclosure, the light apparatus may have at least one second LED chip).

In the frame 30 of this embodiment, the second body 303 is also disposed on a second portion 3012. The second portion 3012 has a second electrode surface 301b opposite to a connection surface 301d, and the second body 303 further has a second recess 303b which may expose the second electrode surface 301b of the second portion 3012. Therefore, two sets of LED chips can be installed simultaneously on the frame 30 of the second embodiment. That is, the first LED chip 31a is accommodated in a first recess 302a to be electrically connected with a first electrode surface 301a of a first portion 3011. The second LED chips 31b are accommodated in the second recess 303b and disposed on the second electrode surface 301b to be electrically connected with the second electrode surface 301b of the electrode portion 301. The sealant 32 may be filled in the second recess 303b to cover the second LED 31b. In this embodiment, the first electrode surface 301a and the connection surface 301b are at the same side.

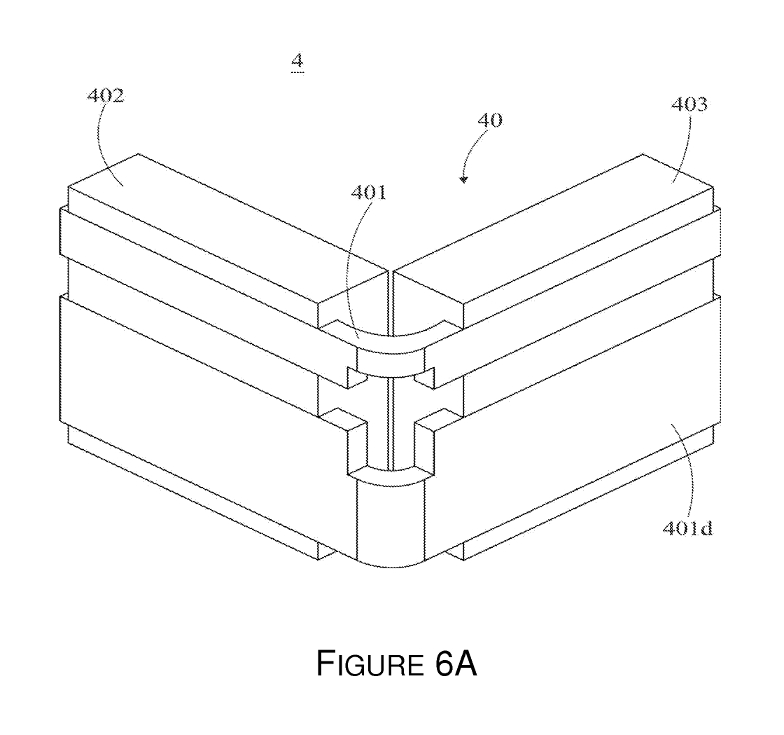

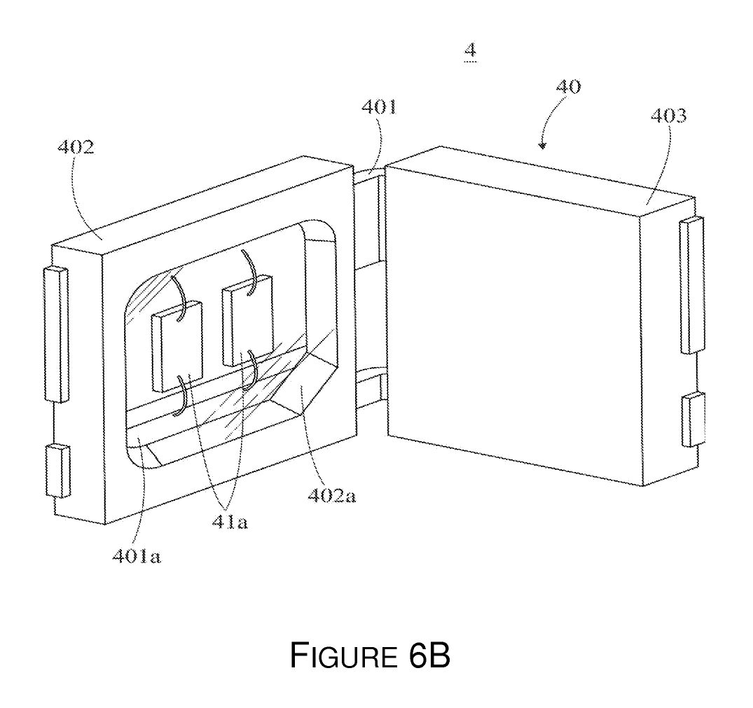

FIGS. 6A and 6B are schematic perspective views of a light apparatus 4 and a frame 40 according to a third embodiment of the present disclosure when being observed from different perspectives.

It shall be appreciated firstly that the frame 40 and the light apparatus 4 of the third embodiment are the same as those of the first embodiment. A first body 402 of the frame 40 has a first recess 402a to expose a first electrode surface 401a. A first LED 41a may also be disposed on the first electrode surface 401a. As in the first embodiment of the present disclosure, a second body 403 of this embodiment may be a block.

However, the third embodiment mainly differs from the first embodiment in that the first body 402 and the second body 403 of this embodiment are at the same side of an electrode portion 401. In other words, the first electrode surface 401a and a connection surface 401d are at different sides of the electrode portion 401. Accordingly, by using the frame 40 of the third embodiment, the LED chips can be installed at angles different from those of the first embodiment to form the light apparatus 4 to generate light rays of different angles.

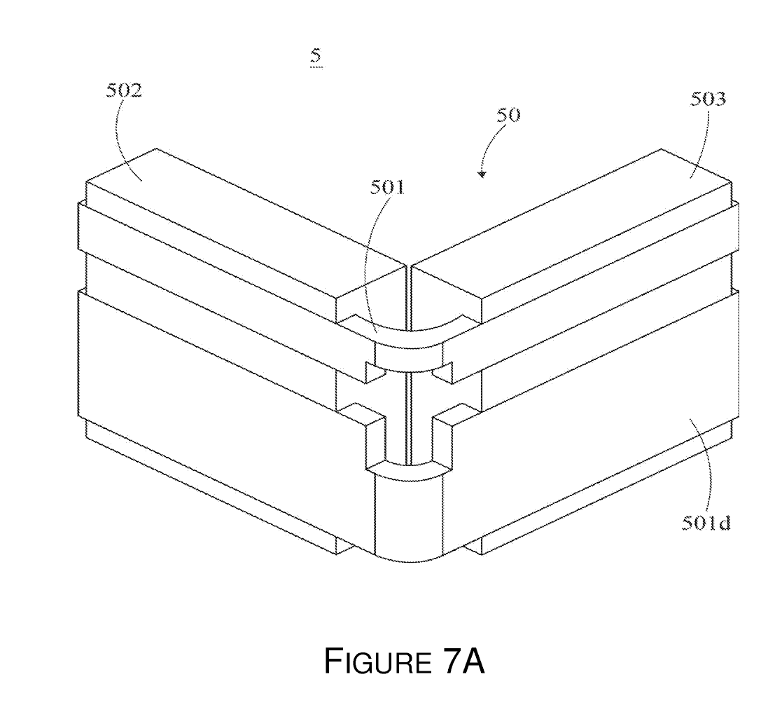

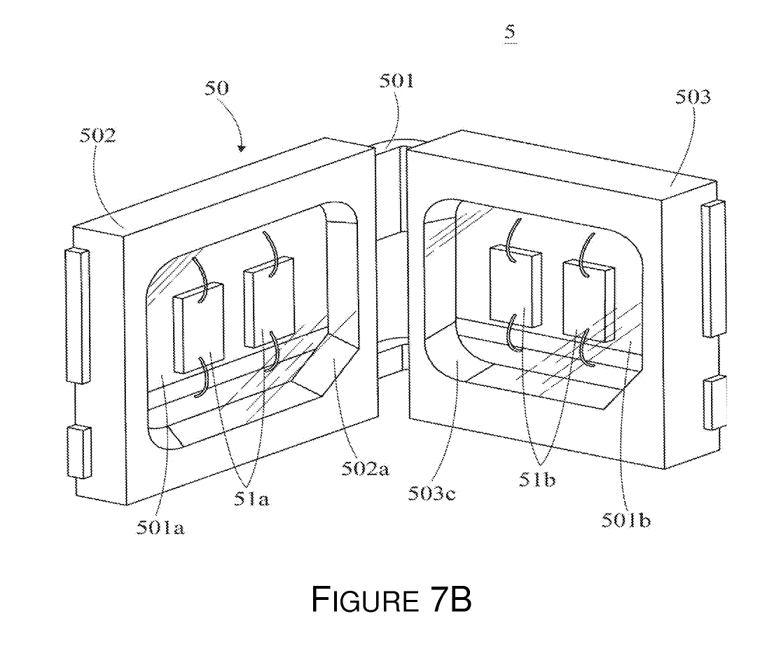

Next, a frame 50 and a light apparatus 5 according to a fourth embodiment of the present disclosure will be described. The fourth embodiment combines the second embodiment with the third embodiment, i.e., changes the number and the position of the bodies in the light apparatus of the first embodiment simultaneously. FIGS. 7A and 7B are schematic perspective views of the light apparatus 5 and the frame 50 according to the fourth embodiment of the present disclosure when being observed from different perspective. Related technical features have been described in the aforesaid descriptions and, thus, will not be further described herein.

This embodiment differs from the second embodiment in that: a first body 502 and a second body 503 of the frame 50 are on the same side of an electrode portion 501. In addition, the first body 502 and the second body 503 may have a first recess 502a and a second recess 503b respectively to expose a first electrode surface 501a and a second electrode surface 501b respectively. The first electrode surface 501a and the second electrode surface 501b are on the same side of the electrode portion 501. A connection surface 501d opposite to the second electrode surface 501b may be additionally electrically connected with other electronic elements or substrates. Thus, by using the frame 50 of this embodiment, a plurality of first LED chips 51a can be disposed on the first electrode surface 501a and a plurality of second LEDs 51b can be disposed on the second electrode surface 501b to form the light apparatus 5. In this way, both the brightness and lighting coverage of the light apparatus can be improved by adjusting the angle of the frame 50.

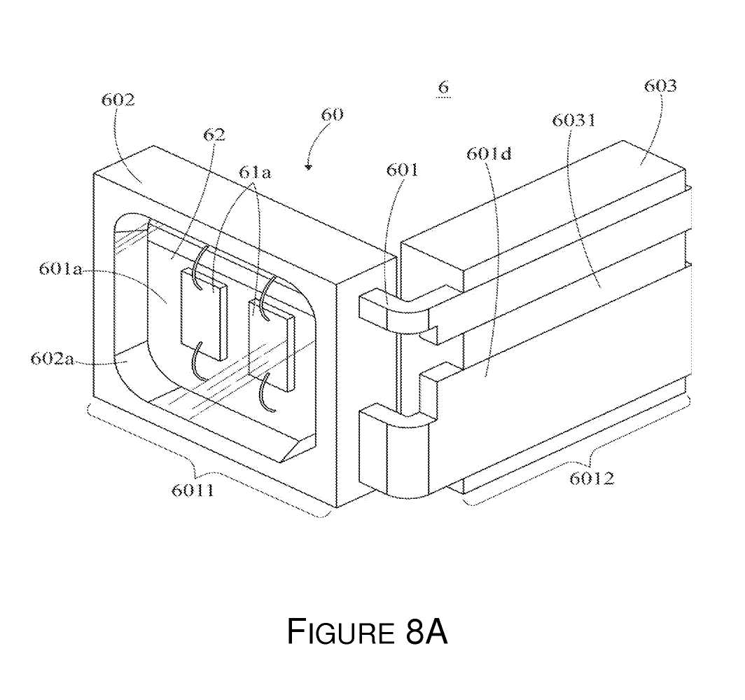

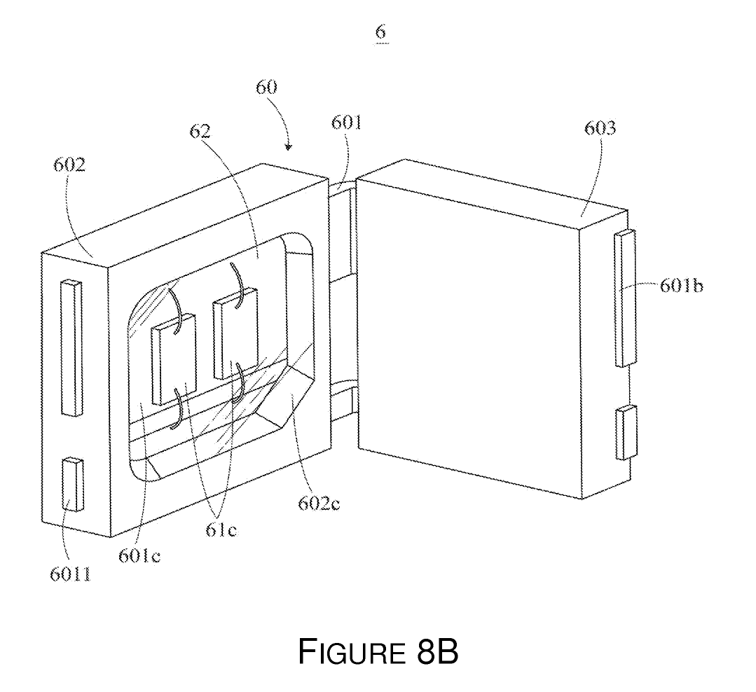

Next, a frame 60 and a light apparatus 6 according to a fifth embodiment of the present disclosure will be described. FIGS. 8A and 8B are schematic perspective views of the light apparatus 6 and the frame 60 of this embodiment when being observed from different perspectives. In addition to a first electrode surface 601a, a second electrode surface 601b and a connection surface 601d, the electrode portion 601 of the frame 60 of this embodiment further has a third electrode surface 601c.

In detail, a third electrode surface 601c may be disposed on a first portion 6011 of the electrode portion 601. The first electrode surface 601a is opposite to the third electrode surface 601c. As shown in FIG. 8A and FIG. 8B, the first electrode surface 601a and the connection surface 601d are on the same side of the electrode portion 601. The second electrode surface 601b and the third electrode surface 601c are on the same side of the electrode portion 601.

In this embodiment, a first body 602 covers two side surfaces of the first portion 6011 of the electrode portion 601 simultaneously, i.e., the first body 602 partially covers the first electrode surface 601a and the third electrode surface 601c simultaneously. The first body 602 has a first recess 602a and a third recess 602c corresponding to the first electrode surface 601a and the third electrode surface 601c respectively. The first recess 602a exposes the first electrode surface 601a of the first portion 6011, while the third recess 602c exposes the third electrode surface 601c of the first portion 6011.

A second bottom surface 6031 of a second body 603 covers a side surface (i.e., the second electrode surface 601b) of a second portion 6012 of the electrode portion 601. The connection surface 601d may be defined as the other side surface which is not covered by the second body 603 and opposite to the second electrode surface 601b. Furthermore, no recess is formed on the second body 603, so the second electrode surface 601b is not connected with any LED chip in this embodiment.

The light apparatus of the present disclosure may comprise at least one first LED chip and at least one third LED chip. In this embodiment, the light apparatus 6 has a plurality of first LED chips 61a and a plurality of third LED chips 61c. The first LED chips 61a are accommodated in the first recess 602a and disposed on the first electrode surface 601a. The third LED chips 61c are accommodated in the third recess 602c and disposed on the third electrode surface 601c. The first LED chips 61a and the third LED chips 61c may be electrically connected with the electrode portion 601. The first recess 602a and the third recess 602c are further filled with a sealant 62 of the light apparatus 6. Thus, two sets of LED chips can be installed on the frame 60 of this embodiment to form the light apparatus 6. The angle of the frame 60 of the light apparatus 6 can be adjusted depending on practical needs so that the two sets of LED chips emit light rays towards different directions to adapt to different applications.

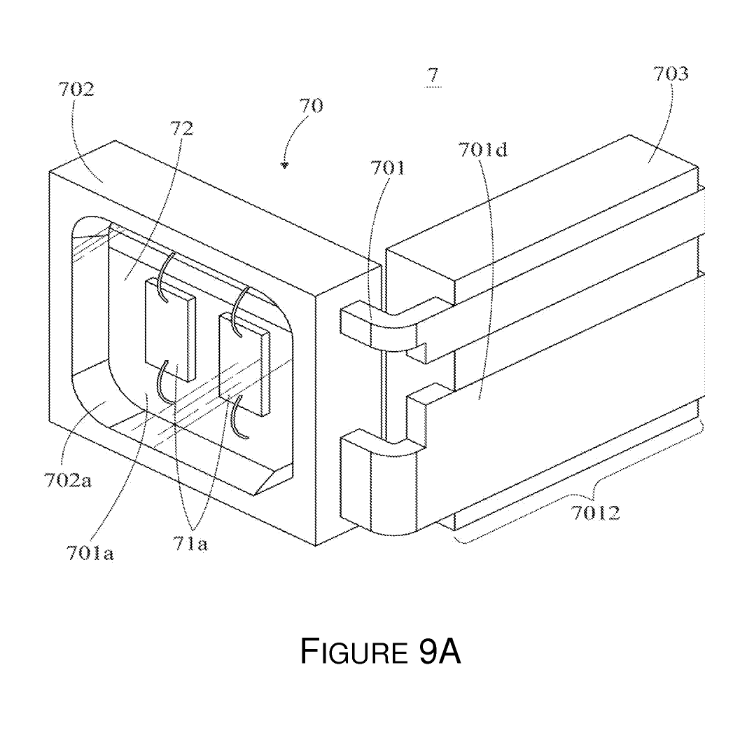

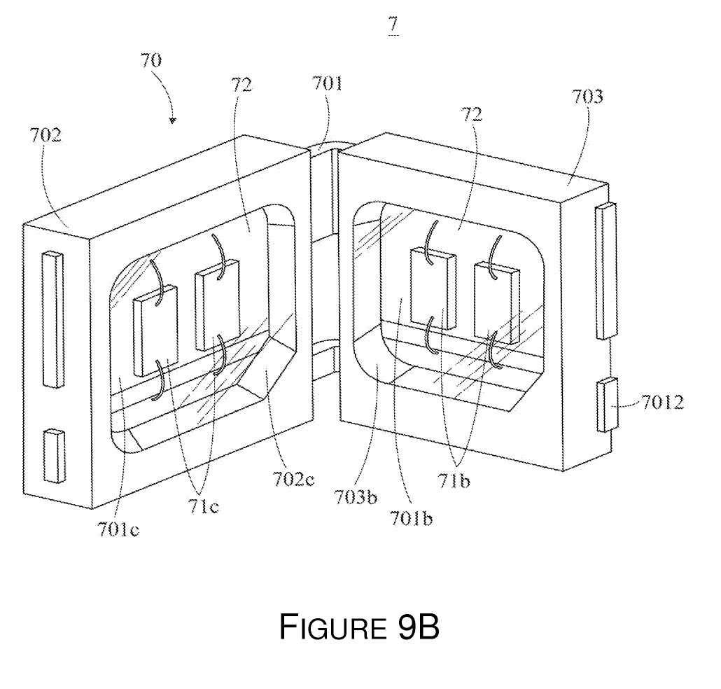

Next, a frame 70 and a light apparatus 7 according to a sixth embodiment of the present disclosure will be described. FIGS. 9A and 9B are schematic perspective views of the light apparatus 7 and the frame 70 according to the sixth embodiment of the present disclosure when being observed from different perspective.

The technical features of the sixth embodiment are similar to those of the fifth embodiment except that a second body 703 of the frame 70 of the sixth embodiment has a second recess 703b exposing a second electrode surface 701b so that the second electrode surface 701b can be electrically connected with electronic elements. Therefore, as compared with the fifth embodiment, one more set of LED chips can be installed on the frame 70 of this embodiment to form the light apparatus 7. That is, in addition to having first LED chips 71a and third LED chips 71c which are accommodated in a first recess 702a and a third recess 702c of a first body 702 of the frame 70 respectively and are electrically connected with a first electrode surface 701a and a third electrode surface 701c of an electrode portion 701 respectively, the light apparatus 7 further has a second LED chip 71b that is accommodated in the second recess 703b to be electrically connected with the second electrode surface 701b of a second portion 7012 of the electrode portion 701. The first recess 702a, the second recess 703b and the third recess 702c may be further filled with a sealant 72 to form the light apparatus 7.

According to the above descriptions, the frame of the present disclosure allows the light-emitting direction of the LED chips disposed on the frame to be adjusted by means of the bendable connection portion of the electrode portion, and can increase the number of LED chips accommodated in the frame by controlling the number of bodies of the frame. Thereby, the LED chips of the light apparatus of the present disclosure can emit light rays at various different angles while being disposed on a substrate, and this can improve the light emitting efficiency, simplify the shape of the substrate and reduce the production cost.

The above disclosure is related to the detailed technical contents and inventive features thereof. People skilled in this field may proceed with a variety of modifications and replacements based on the disclosures and suggestions of the present disclosure as described without departing from the characteristics thereof. Nevertheless, although such modifications and replacements are not fully disclosed in the above descriptions, they have substantially been covered in the following claims as appended.

In the above description of exemplary implementations, for purposes of explanation, specific numbers, materials configurations, and other details are set forth in order to better explain the present disclosure, as claimed. However, it will be apparent to one skilled in the art that the claimed subject matter may be practiced using different details than the exemplary ones described herein. In other instances, well-known features are omitted or simplified to clarify the description of the exemplary implementations.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

For the purposes of this disclosure and the claims that follow, the terms “coupled” and “connected” may have been used to describe how various elements interface. Such described interfacing of various elements may be either direct or indirect.

What is claimed is:

1. A frame for use in a light apparatus, comprising:
an electrode portion having a first portion, a second portion and a connection portion located between the first portion and the second portion, wherein an angle is formed between the first portion and the second portion by the connection portion;
a first body disposed on the first portion, wherein the first body has a first recess partially exposing a first electrode surface of the first portion; and
a second body disposed on the second portion, wherein the second body exposes a connection surface of the second portion.

2. The frame as claimed in claim 1, wherein the first body has a third recess exposing a third electrode surface of the first portion.

3. The frame as claimed in claim 2, wherein the first electrode surface is opposite to the third electrode surface.

4. The frame as claimed in claim 1, wherein the second body has a second recess exposing a second electrode surface of the second portion.

5. The frame as claimed in claim 4, wherein the second electrode surface is opposite to the connection surface.

6. The frame as claimed in claim 1, wherein the first electrode surface and the connection surface are located at a same side or at different sides of the electrode portion.

7. The frame as claimed in claim 1, wherein a ratio of a weight of the first body to a weight of the second body is 0.8 or less.

8. The frame as claimed in claim 1, wherein the angle is between 0 degree and 180 degrees.

9. The frame as claimed in claim 1, wherein the connection portion is covered by an insulating layer.

10. The frame as claimed in claim 9, wherein the insulating layer is covered by a reflective layer.

11. A light apparatus, comprising:
a frame, comprising:
an electrode portion having a first portion, a second portion and a connection portion located between the first portion and the second portion, wherein an angle is formed between the first portion and the second portion by the connection portion;
a first body disposed on the first portion, wherein the first body has a first recess partially exposing a first electrode surface of the first portion; and
a second body disposed on the second portion, wherein the second body exposes a connection surface of the second portion;
at least one first light-emitting diode chip accommodated in the first recess and electrically connected with the electrode portion; and
a sealant accommodated in the first recess and adapted to cover the at least one first light-emitting diode chip and the first electrode surface.

12. The light apparatus as claimed in claim 11, wherein the first body has a third recess exposing a third electrode surface of the first portion.

13. The light apparatus as claimed in claim 12, wherein the first electrode surface is opposite to the third electrode surface.

14. The light apparatus as claimed in claim 11, wherein the second body has a second recess exposing a second electrode surface of the second portion.

15. The light apparatus as claimed in claim 14, wherein the second electrode surface is opposite to the connection surface.

16. The light apparatus as claimed in claim 11, wherein the first electrode surface and the connection surface are located at a same side or at different sides of the electrode portion.

17. The light apparatus as claimed in claim 11, wherein a ratio of a weight of the first body to a weight of the second body is 0.8 or less.

18. The light apparatus as claimed in claim 11, wherein the angle is between 0 degree and 180 degrees.

19. The light apparatus as claimed in claim 11, wherein the connection portion is covered by an insulating layer.

20. The light apparatus as claimed in claim 19, wherein the insulating layer is covered by a reflective layer.
